(19) United States
(12) Patent Application Publication
(10) Pub. No.: US 2025/0370881 A1
(43) Pub. Date: Dec. 4, 2025

(54) BACKUP SCHEDULE CREATION DEVICE AND BACKUP SCHEDULE CREATION METHOD

(71) Applicant: Hitachi, Ltd., Tokyo (JP)

(72) Inventor: Ryoma MATSUYAMA, Tokyo (JP)

(73) Assignee: Hitachi, Ltd., Tokyo (JP)

(21) Appl. No.: 19/051,593

(22) Filed: Feb. 12, 2025

(30) Foreign Application Priority Data
May 28, 2024 (JP) 2024-086179

(51) Int. Cl. G06F 11/14

(52) U.S. Cl. CPC G06F 11/1461; G06F 11/1451; G06F 11/1464

(57) ABSTRACT

A backup schedule management device according to one aspect of the present invention includes: a predicted backup time calculation unit that calculates a predicted backup time for each combination of a data transfer server and a backup target server on the basis of a temporary backup throughput and a used capacity of the backup data in the backup target server; and a schedule creation unit that sequentially assigns a backup process of the backup target server to the data transfer server on the basis of the information of the predicted backup time and the information of the degree of use of the network, and creates the backup schedule on the basis of a result of the assignment.

### BACKGROUND OF THE INVENTION

### 1. Field of the Invention

The present invention relates to a backup schedule creation device and a backup schedule creation method.

### 2. Description of the Related Art

In recent years, there is an increasing number of systems provided with a data transfer server for data that needs to be backed up. The data transfer server transfers data to be backed up (hereinafter also referred to as “backup data”) to a backup storage. Even when there are a plurality of machines to be subjected to the backup process in the system, it is possible to execute the backup process in parallel by disposing a plurality of data transfer servers in the system. In such a system, it is required to complete all the backup processes within a limited allowable backup time (hereinafter also referred to as “backup window”).

For example, a backup management program described in JP 2023-009583 A acquires, from each data transfer device, a first amount of data transmitted to the backup storage and a second amount of data not transmitted to the backup storage by the deduplication function among data previously assigned to each data transfer device. In addition, the backup management program calculates a previous transmission data amount transmitted to the backup storage by the plurality of data transfer devices based on the acquired first data amount. In addition, the backup management program calculates a next transmission data amount to be transmitted to the backup storage based on the acquired first data amount, second data amount, and size of the backup target data. Further, the backup management program increases or decreases the number of the plurality of data transfer devices based on a result of comparison between the calculated previous transmission data amount and the next transmission data amount. According to the technology described in JP 2023-009583 A, it is possible to control a resource used for backup such that the backup is completed within an assumed time.

In addition, for example, a job scheduler described in JP 2013-513150 A receives input of task information, replica arrangement data, infrastructure topology data, and resource performance data from an archive management system. The job scheduler also models a flow network representing the archive management system's data content, software programs, physical devices, and communication capacity at various levels of vertices in accordance with the received inputs. An optimal path in the modeled flow network is calculated as an initial schedule, and the archive management system performs a task according to the initial schedule. Operation of the scheduled task is monitored and the job scheduler creates a new schedule based on feedback of the monitored operation and predetermined heuristics. According to the technology described in JP 2013-513150 A, an optimal (fastest) network path can be derived as a schedule from information of a communication capacity and a network topology, and can be applied to a management system.

### SUMMARY OF THE INVENTION

Meanwhile, in recent years, backup data may rapidly increase due to ease of environmental scale, ease of data increase, and the like. When the backup data rapidly increases, a situation may occur in which the backup process does not complete the entire backup process within the backup window in the preset combination of the data transfer server and the backup target machine. If the entire backup process is not performed within the backup window, the recovery point objective (RPO) cannot be satisfied.

The present invention has been made in view of the above circumstances, and an object of the present invention is to make it possible to create an appropriate backup schedule even in a system in which it is difficult to predict a change in the capacity of backup data.

A backup schedule creation device according to one aspect of the present invention creates a backup schedule for a backup process in a backup schedule management system in which a plurality of backup target servers having backup data to be backed up in a data storage server and a plurality of data transfer servers that acquire the backup data from the backup target servers and transfer the backup data to the data storage server are connected to each other via a network. The backup schedule creation device according to one aspect of the present invention includes: a predicted backup time calculation unit that calculates a predicted backup time for each combination of the data transfer server and the backup target server on the basis of an estimated backup throughput at the time of transmission of the backup data and a used capacity of the backup data in the backup target server; and a schedule creation unit that sequentially assigns a backup process of the backup data of the backup target server to the data transfer server on the basis of the information of the predicted backup time and the information of the degree of use of the network during execution of the backup process, and creates the backup schedule on the basis of a result of the assignment.

According to at least one aspect of the present invention, it is possible to create an appropriate backup schedule even in a system in which it is difficult to predict a change in the capacity of the backup data.

Problems, configurations, and effects other than those described above will be clarified by the following description of embodiments.

### BRIEF DESCRIPTION OF THE DRAWINGS

FIG. 1 is a block diagram illustrating a schematic configuration example of a backup schedule management system according to one embodiment of the present invention;

FIG. 2 is a block diagram illustrating a hardware configuration example of each of a server and a backup schedule management device constituting the backup schedule management system according to one embodiment of the present invention;

FIG. 3 is a diagram illustrating a configuration example of a backup job table according to one embodiment of the present invention;

FIG. 4 is a diagram illustrating a configuration example of a VM configuration information table according to one embodiment of the present invention;

FIG. 5 is a diagram illustrating a configuration example of a backup data path table according to one embodiment of the present invention;

FIG. 6 is a diagram illustrating a configuration example of a predicted backup time table according to one embodiment of the present invention;

FIG. 7 is a graph showing a length of predicted temporary backup time in each combination of a backup target server and a data transfer server indicated in the predicted backup time table according to one embodiment of the present invention;

FIG. 8 is a diagram illustrating a configuration example of a provisional backup schedule table according to one embodiment of the present invention;

FIG. 9 is a diagram illustrating an example of correspondence between a backup target server and a data transfer server after an assigning process is performed by a schedule creation unit according to one embodiment of the present invention;

FIG. 10 is a diagram illustrating a configuration example of a candidate backup schedule table which is a modified provisional backup schedule table according to one embodiment of the present invention;

FIG. 11 is a diagram illustrating an outline of a correction process of a provisional backup schedule table by a schedule creation unit according to one embodiment of the present invention;

FIG. 12 is a diagram illustrating an outline of the correction process of the provisional backup schedule table by the schedule creation unit according to one embodiment of the present invention;

FIG. 13 is a diagram illustrating an outline of the correction process of the provisional backup schedule table by the schedule creation unit according to one embodiment of the present invention;

FIG. 14 is a flowchart illustrating an example of a procedure of a backup schedule management process by the backup schedule management system according to one embodiment of the present invention;

FIG. 15 is a flowchart illustrating an example of a procedure of a predicted backup time table creation process by a predicted backup time calculation unit according to one embodiment of the present invention;

FIG. 16 is a flowchart illustrating an example of a procedure of a provisional backup schedule table creation process by a schedule creation unit according to one embodiment of the present invention;

FIG. 17 is a flowchart illustrating an example of a procedure of the provisional backup schedule table creation process by the schedule creation unit according to one embodiment of the present invention;

FIG. 18 is a flowchart illustrating an example of a procedure of a candidate backup schedule table creation process by a schedule creation unit according to one embodiment of the present invention;

FIG. 19 is a flowchart illustrating an example of a procedure of the candidate backup schedule table creation process by the schedule creation unit according to one embodiment of the present invention;

FIG. 20 is a flowchart illustrating an example of a procedure of a backup schedule determination process by the schedule creation unit according to one embodiment of the present invention;

FIG. 21 is a diagram illustrating a configuration example of a candidate backup schedule selection screen according to one embodiment of the present invention; and

FIG. 22 is a flowchart illustrating an example of a procedure of a predicted backup time table update process by the schedule creation unit according to one embodiment of the present invention.

### DESCRIPTION OF THE PREFERRED EMBODIMENTS

Hereinafter, embodiments of the present invention will be described with reference to the drawings. In the drawings, the same components are denoted by the same reference numerals. The following description and drawings are examples for describing the present invention, and omission and simplification are made as appropriate for the sake of clarity of description. The present invention can be implemented in various other forms. Unless otherwise specified, each component may be plural or singular.

### Configuration of Backup Schedule Management System

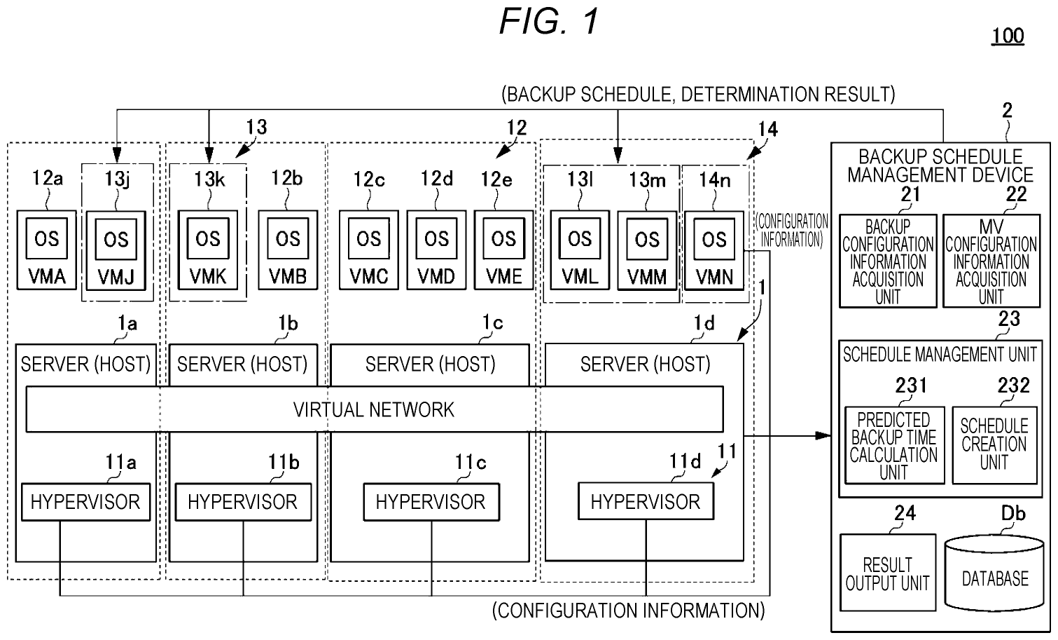

First, a configuration of a backup schedule management system 100 according to one embodiment of the present invention will be described with reference to FIG. 1. FIG. 1 is a block diagram illustrating a schematic configuration example of the backup schedule management system 100.

As illustrated in FIG. 1, the backup schedule management system 100 includes a server (host) 1 and a backup schedule management device 2. The server 1 includes servers 1a to 1d. In the servers 1a to 1d, hypervisors 11a to 11d for creating and executing a virtual machine (VM) on the server are respectively installed.

A VMA 12a and a VMJ 13j are configured in the server 1a, and a VMK 12k and a VMB 12b are configured in the server 1b. A VMC 12c to a VME 12e are configured in the server 1c, and a VML 13l, a VMN 13n, and a VMN 14n are configured in the server 1d.

The VMA 12a to the VME 12e are the backup target servers 12 having backup data. The VMJ 13j to the VMM 13m surrounded by a one-dot chain line in the drawing are data transfer servers 13 that collect backup data from the backup target server 12 and store the backup data in the data storage server 14. In the drawing, the VMN 14n surrounded by a frame of a two-dot chain line is the data storage server 14 that stores the backup data of the VMA 12a to the VME 12e collected based on the backup process by the data transfer server 13.

The backup schedule management device 2 (an example of a backup schedule creation device) creates a schedule for a backup process. Then, the backup schedule management device 2 notifies the created backup schedule and the determination result as to whether or not the backup process based on the backup schedule is possible to the VMJ 13j to the VMM 13m of the data transfer server 13.

Note that the number of servers 1 in the backup schedule management system 100, the number of VMs deployed in the server 1, and the ratio among the backup target server 12, the data transfer server 13, and the data storage server 14 are not limited to the example illustrated in FIG. 1. In addition, the backup target server 12, the data transfer server 13, and the data storage server 14 may be provided in a cloud environment or the like.

The backup schedule management device 2 includes a backup configuration information acquisition unit 21, a VM configuration information acquisition unit 22, a schedule management unit 23, a result output unit 24, and a database Db.

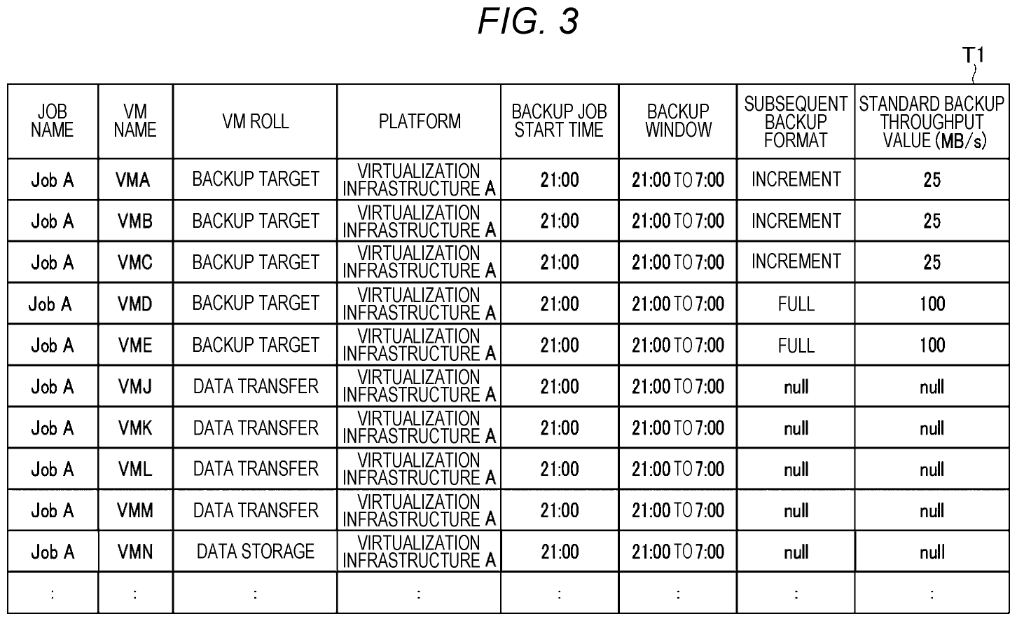

The backup configuration information acquisition unit 21 acquires the backup configuration information from the data storage server 14 and creates the backup job table T1 (see FIG. 3). The backup configuration information is information of each element constituting a backup job that is a job in the backup process. A configuration example of the backup job table T1 will be described in detail with reference to FIG. 3 described later.

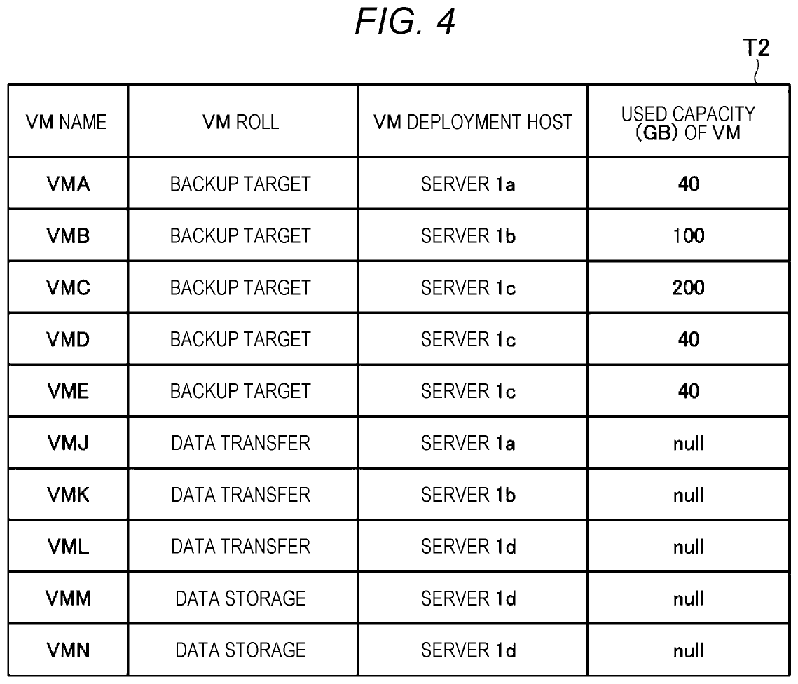

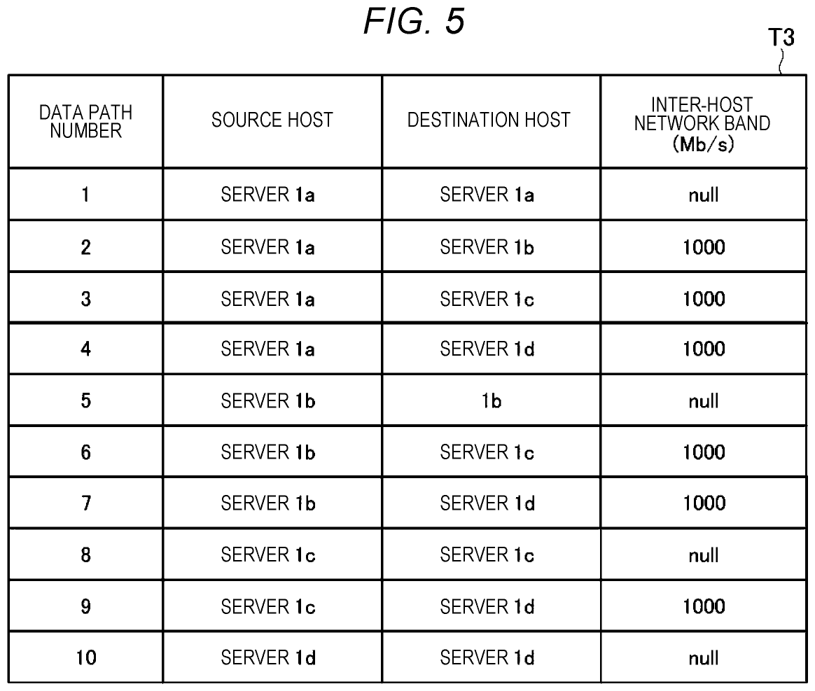

The VM configuration information acquisition unit 22 acquires configuration information of each server 1 constituting the backup schedule management system 100 and acquires configuration information of each VM from the hypervisor 11 of each server 1. Then, the VM configuration information acquisition unit 22 creates the VM configuration information table T2 (see FIG. 4) based on the acquired configuration information. In addition, the VM configuration information acquisition unit 22 creates the backup data path table T3 (see FIG. 5) on the basis of the acquired configuration information. A configuration example of the VM configuration information table T2 will be described in detail with reference to FIG. 4 to be described later, and a configuration example of the backup data path table T3 will be described in detail with reference to FIG. 5 to be described later.

The schedule management unit 23 includes a predicted backup time calculation unit 231 and a schedule creation unit 232.

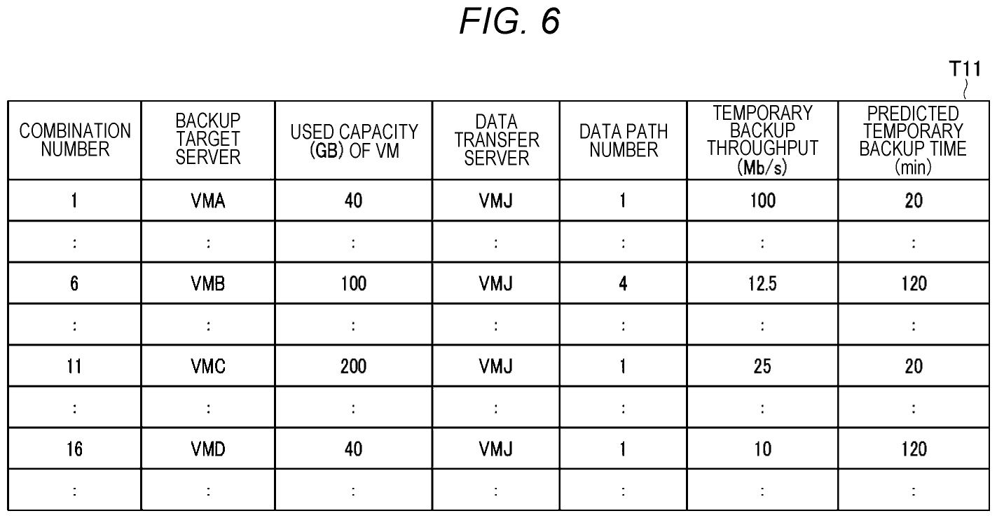

The predicted backup time calculation unit 231 creates a predicted backup time table T11 (see FIG. 6) based on the backup job table T1, the VM configuration information table T2, and the backup data path table T3. The predicted backup time table T11 is a table that stores the temporary backup throughput for each combination of the backup target server 12 and the data transfer server 13 and the predicted backup time required for the backup process. The predicted backup time table T11 will be described in detail with reference to FIG. 6 described later.

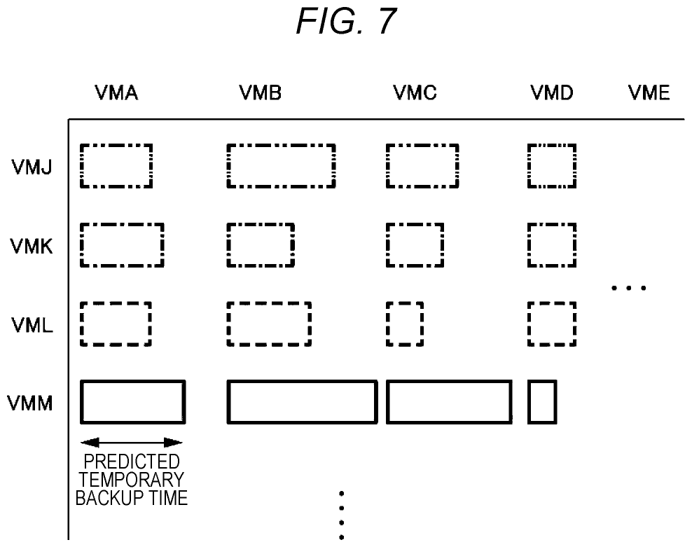

The schedule creation unit 232 creates a provisional backup schedule table T12 (see FIG. 7) based on the information described in the predicted backup time table T11. The provisional backup schedule table T12 is a table indicating a result of assigning compatible data transfer servers in descending order from the backup target server of the greatest predicted backup time. The provisional backup schedule table T12 will be described in detail with reference to FIG. 7 described later.

In addition, the schedule creation unit 232 corrects the provisional backup schedule table T12 on the basis of information such as the degree of dispersion of the data path usage status during the backup process and the relationship between the backup throughput in each data path and the network band. Then, the schedule creation unit 232 sets the corrected provisional backup schedule table T12 as the candidate backup schedule table T13. In the present embodiment, the schedule creation unit 232 generates a plurality of candidate backup schedule tables T13 having different obtained effects. For example, the schedule creation unit 232 can create the candidate backup schedule table T13 corresponding to each of the backup schedule having the earliest backup completion time and the backup schedule having the largest degree of network dispersion at the time of the backup process.

Further, the schedule creation unit 232 creates a backup schedule using the candidate backup schedule table T13 selected on the basis of a predetermined determination criterion or selected by the user. In addition, the schedule creation unit 232 updates the predicted backup time table T11 (see FIG. 6) using the processing result after the completion of the actual backup process based on the created backup schedule.

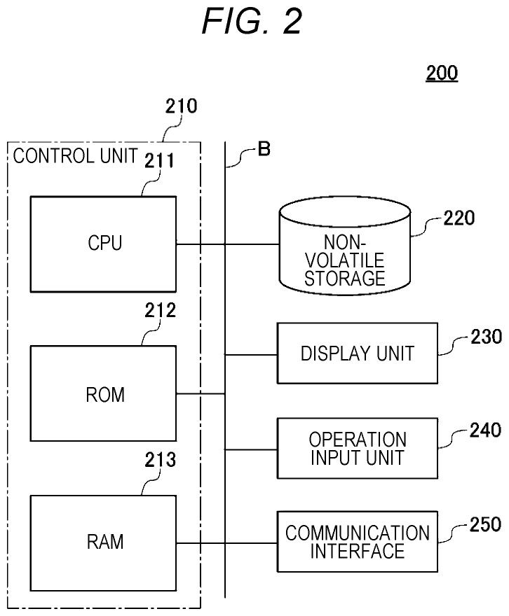

The result output unit 24 presents the candidate backup schedule table T13, the finally determined backup schedule, and the like to the user via a screen or the like of the display unit 230 (see FIG. 2).

The database Db stores a backup job table T1, a VM configuration information table T2, a backup data path table T3, a predicted backup time table T11, a provisional backup schedule table T12, a candidate backup schedule table T13, and the like.

### Hardware Configuration Example of Computer

Next, a hardware configuration of the device for implementing the functions of the backup schedule management system 100 according to the present embodiment will be described with reference to FIG. 2. FIG. 2 is a block diagram illustrating a hardware configuration example of each of the server 1 and a backup schedule management device 2 constituting the backup schedule management system 100. The computer 200 illustrated in FIG. 2 is hardware used as a so-called computer.

The computer 200 includes a control unit 210 connected to a bus B, a non-volatile storage 220, a display unit 230, an operation input unit 240, and a communication interface (I/F) 250.

The control unit 210 includes a central processing unit (CPU) 211, a read only memory (ROM) 212, and a random access memory (RAM) 213.

The CPU 211 reads a program code of software for realizing each function according to the present embodiment from the ROM 212, develops the program code in the RAM 213, and executes the program code. Variables, parameters, and the like generated during arithmetic processing are temporarily written to the RAM 213.

Note that the control unit 210 may include a processing device such as a micro-processing unit (MPU) instead of the CPU 211. Alternatively, the CPU and the MPU may be used in combination in the control unit 210.

As the non-volatile storage 220, for example, a hard disk drive (HDD), a solid state drive (SSD), a flexible disk, an optical disk, a magneto-optical disk, a CD-ROM, a CD-R, a nonvolatile memory card, or the like can be used. In addition to an OS and various parameters, a program for causing the computer 200 to function, and the like are recorded in the non-volatile storage 220. The program may also be stored in the ROM 212.

The display unit 230 is, for example, a monitor including a liquid crystal display (LCD) or the like, and displays a result of process performed by the computer 200 and the like.

The operation input unit 240 includes, for example, a keyboard, a mouse, a touch sensor, and the like, generates an operation signal according to an operation by the user, and supplies the operation signal to the CPU 211.

Note that the display unit 230 and the operation input unit 240 may be integrally configured as a touch panel.

The program is stored in the form of a computer-readable program code, and the CPU 211 sequentially executes an operation according to the program code. That is, the ROM 212 or the non-volatile storage 220 is used as an example of a computer-readable non-transitory recording medium storing a program to be executed by a computer.

For example, a network interface card (NIC) or the like is used as the communication I/F 250, and various data can be transmitted and received to and from an external device via a network or a communication line.

### Configuration of Backup Job Table T1

Next, a configuration of the backup job table T1 will be described with reference to FIG. 3. FIG. 3 is a diagram illustrating a configuration example of the backup job table T1.

As illustrated in FIG. 3, the backup job table T1 includes items “job name”, “VM name”, “VM role”, “platform”, “backup job start time”, “backup window”, “subsequent backup format”, and “standard backup throughput value (MB/s)”.

In the item “job name”, information of the job name of the backup job is stored. In the item “VM name”, information of a name (VM name) given to the VM is stored. In the item “VM role”, information of a role (VM role) assigned to the VM is stored. For example, any one of “backup target”, “data transfer”, and “data storage” illustrated in the drawing is stored in the VM role.

In the item “platform”, information of the name of the platform that implements virtualization is stored. In the item “backup job start time”, information of the start time of the backup job is stored. In the item “backup window”, information of the start time and end time of the backup window is stored.

In the item “subsequent backup format”, information of the backup format of the subsequent backup process to be performed in the backup target server 12 is stored. In the example illustrated in FIG. 3, “increment”, “full”, “null”, and the like are stored in the item “subsequent backup format”. “Increment” indicates an incremental backup in which data incremented from the time of execution of the previous backup process is backed up, and “full” indicates a full backup in which all data is backed up. “null” indicates that backup is not performed.

In the item “standard backup throughput value (MB/s)”, information of a standard backup throughput value determined by the backup format stored in the “subsequent backup format” is stored. The “standard backup throughput value (MB/s)” is stored in the item “temporary backup throughput (MB/s)” as a temporary value in a predicted backup time table T11 illustrated in FIG. 6 to be described later.

For example, the uppermost record in the backup job table T1 illustrated in FIG. 3 indicates that the backup job having the job name “Job A” is a job executed for the VMA 12a that is the backup target server 12. In addition, the uppermost record indicates that the virtualization platform of the VM is “virtualization infrastructure A”, the start time of the backup job is “21:00”, and the backup window is “21:00-7:00”. Further, the uppermost record indicates that a subsequent backup format is “incremental”, and a standard backup throughput value is “25 (MB/s)”.

### Configuration of VM Configuration Information Table

Next, the VM configuration information table T2 will be described with reference to FIG. 4. FIG. 4 is a diagram illustrating a configuration example of the VM configuration information table T2.

As illustrated in FIG. 4, the VM configuration information table T2 includes items “VM name”, “VM role”, “VM deployment host”, and “used capacity (GB) of VM”.

In the item “VM name”, the name of the VM is stored. In the item “VM role”, information of the role assigned to the VM is stored. In the item “VM deployment host”, information of a host (server) in which the VM is deployed is stored. In the item “used capacity of the VM”, information of the used capacity (GB) of the data of the VM is stored.

For example, the uppermost record of the VM configuration information table T2 illustrated in FIG. 4 indicates that the VM role of the VMA 12a of which VM name is “VMA” is “backup target (server)”, the host in which the VMA 12a is deployed is “server 1a”, and the used capacity of the VM is “40 (GB)”.

### Configuration of Backup Data Path Table

Next, the configuration of the backup data path table T3 will be described with reference to FIG. 5. FIG. 5 is a diagram illustrating a configuration example of the backup data path table T3.

As illustrated in FIG. 5, the backup data path table T3 includes items “data path number”, “source host”, “destination host”, and “inter-host network band (Mb/s)”.

In the item “data path number”, information of a data path number which is a number for identifying the path of the backup data is stored. In the item “source host”, information of the name of the server 1 in which the backup target server 12 serving as the transmission source of the backup data is disposed is stored. In the item “destination host”, information of the name of the server 1 in which the data transfer server 13 serving as the transmission destination of the backup data is disposed is stored. In the item “inter-host network band (Mb/s)”, when backup data is transmitted from the source host to the destination host, information of a network band that occupies a transmission path of the backup data is stored.

For example, the uppermost record of the backup data path table T3 illustrated in FIG. 5 indicates that in the data path of which data path number is “1”, both the source host and the destination host are “server 1a”, and the inter-host network band is “null”. In addition, the second record from the top shows that a data path of which data path number is “2” has a source host of “server 1a”, a destination host of “server 1b”, and an inter-host network band of “1000 (Mb/s)”.

### Predicted Backup Time Table

Next, the configuration of the predicted backup time table T11 will be described with reference to FIG. 6. FIG. 6 is a diagram illustrating a configuration example of the predicted backup time table T11. The predicted backup time table T11 is a table created by the predicted backup time calculation unit 231 of the schedule management unit 23 on the basis of the information recorded in the backup job table T1, the VM configuration information table T2, and the backup data path table T3.

As illustrated in FIG. 6, the predicted backup time table T11 includes items “combination number”, “backup target server”, “used capacity (GB) of VM”, “data transfer server”, “data path number”, “temporary backup throughput (Mb/s)”, and “predicted temporary backup time (minutes)”.

In the item “combination number”, information of a combination number which is a number for identifying a combination of the backup target server 12 which is the transmission source of the backup data and the data transfer server 13 which is the transmission destination is stored.

In the item “backup target server”, information of the name of the backup target server 12 is stored. In the item “used capacity of VM (GB)”, information of the data used capacity in the backup target server 12 is stored. In the item “data transfer server”, information of the name of the data transfer server 13 is stored. In the item “data path number”, information of a data path number of a data path used in a combination of the backup target server 12 and the data transfer server 13 is stored.

In the item “temporary backup throughput (Mb/s)”, a value of an estimated backup throughput derived from information of a data path and a network band occupied at the time of using the data path is stored as the temporary backup throughput.

In the item “predicted temporary backup time (minutes)”, an estimated predicted backup time calculated from the backup capacity of the VM and the temporary backup throughput is stored as the predicted temporary backup time.

For example, the uppermost record of the predicted backup time table T11 illustrated in FIG. 6 indicates that the data used capacity of the VMA12a of the backup target server 12 in the combination number “1” is “40 (GB)”. Furthermore, the uppermost record indicates that the data transfer server is “VMJ 13j”, the data path number is “1”, the temporary backup throughput is “100 (Mb/s)”, and the predicted temporary backup time is “20 (minutes)”.

FIG. 7 is a graph showing the length of the predicted temporary backup time in each combination of the backup target server 12 and the data transfer server 13 illustrated in the predicted backup time table T11. In the graph shown in FIG. 7, the vertical axis represents the data transfer server 13, and the horizontal axis represents the backup target server 12. The predicted backup time calculation unit 231 (see FIG. 1) of the schedule management unit 23 creates a provisional backup schedule table T12 on the basis of the information of the length of the predicted temporary backup time in each combination of the backup target server 12 and the data transfer server 13 illustrated in FIG. 7.

### Configuration of Provisional Backup Schedule Table

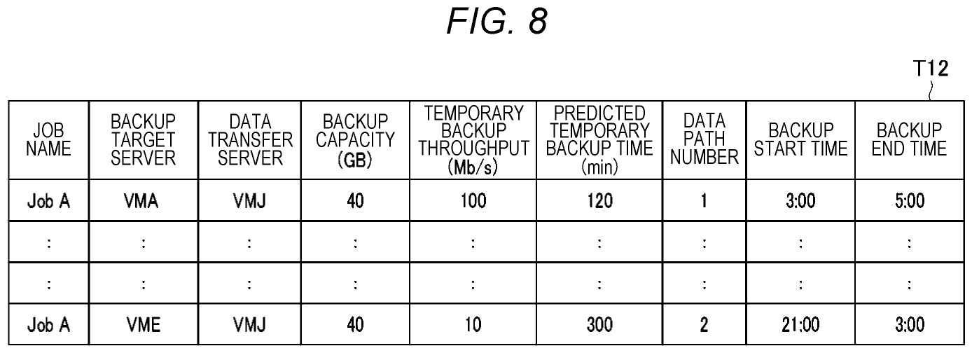

Next, a configuration of the provisional backup schedule table T12 will be described with reference to FIG. 8. FIG. 8 is a diagram illustrating a configuration example of the provisional backup schedule table T12.

As illustrated in FIG. 8, the provisional backup schedule table T12 includes items “job name”, “backup target server”, “data transfer server”, “backup capacity (GB)”, “temporary backup throughput (Mb/s)”, “predicted temporary backup time (minutes)”, “data path number”, “backup start time”, and “backup end time”.

In the item “job name”, information of the job name of the backup job is stored. In the item “backup target server”, information of the name of the backup target server 12 is stored. In the item “data transfer server”, information of the name of the data transfer server 13 is stored. In the item “backup capacity (GB)”, information of the capacity of the backup data of the backup target server 12 is stored.

The value of the temporary backup throughput in the predicted backup time table T11 (see FIG. 6) is stored in the item “temporary backup throughput (Mb/s)”. Information of the predicted temporary backup time of the predicted backup time table T11 is stored in the item “predicted temporary backup time (minutes)”. In the item “data path number”, information of a number of a data path determined by the combination of the backup target server 12 and the data transfer server 13 is stored. Information of the start time of the backup process is stored in the item “backup start time”. In the item “backup end time”, information of the end time of the backup process is stored.

For example, the uppermost record of the provisional backup schedule table T12 illustrated in FIG. 8 indicates backup process information of backup data of a job of which job name is Job A from the VMA 12a of the backup target server 12 to the VMJ 13j which is the data transfer server 13. In addition, the uppermost record indicates that the backup capacity of the VMA 12a is “40 (GB)”, the temporary backup throughput is “100 (Mb/s)”, and the predicted backup time is “120 (minutes)”. Furthermore, the uppermost record indicates that the data path number of the network used by the combination of the VMA 12a and the VMJ 13j is “1”, the backup start time is “3:00”, and the backup end time is “5:00”.

The schedule creation unit 232 (see FIG. 1) of the schedule management unit 23 performs a process of assigning the backup target server 12 to the data transfer server 13 on the basis of the contents recorded in the provisional backup schedule table T12. At this time, the schedule creation unit 232 performs assignment to the data transfer server 13 in order from the backup target server 12 having the largest minimum value of the predicted backup time.

For example, in the example illustrated in FIG. 7, in the VMA 12a that is the backup target server 12, the predicted backup time in the combination with the VML 13l that is the data transfer server 13 is minimized. Similarly, in the VMB 12b, the predicted backup time in the pair with the VMK 13k is minimized, and in the VMC 12c, the predicted backup time in the combination with the VML 13l is minimized. In addition, in the VMD 12d, the predicted backup time in the combination with the VMJ 13j is minimized. The backup target servers 12 are assigned to the data transfer server 13 in an order from the one with the maximum predicted backup time among these minimum predicted backup times.

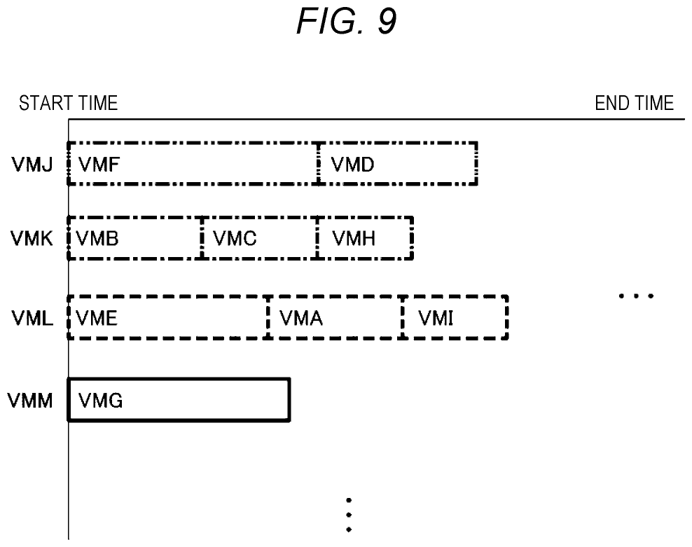

FIG. 9 is a diagram illustrating an example of correspondence between the backup target server 12 and the data transfer server 13 after the assigning process is performed by the schedule creation unit 232. In FIG. 9, the vertical axis represents the data transfer server 13, and the horizontal axis represents a time axis from the backup start time to the end time. In FIG. 9, in order to facilitate understanding of the description of the assigning process of the backup target server 12 to the data transfer server 13, a case where there are more backup target servers 12 than those illustrated in FIG. 1 (there are VMs after the VMF) will be described as an example.

In the example illustrated in FIG. 9, the VMF which is the backup target server 12 having the largest predicted backup time and the next largest VMD 12d are assigned to the VMJ 13j which is the data transfer server 13 in order from the earliest backup start time. To the VMK 13k, the VMB 12b having the largest predicted backup time, the VMC 12c having the next largest predicted backup time, and the VMH having the next largest predicted backup time are assigned in order from the earliest backup start time.

Note that the process in which the schedule creation unit 232 assigns the backup target server 12 having a larger predicted backup time to a time having an earlier backup process time by the data transfer server 13 is an example, and the present invention is not limited thereto. The schedule creation unit 232 may assign a schedule of an earlier time to the data transfer server 13 in order from the backup target server 12 having a shorter predicted backup time.

After completion of the assignment of the backup target server 12 to the data transfer server 13, the schedule creation unit 232 corrects the provisional backup schedule table T12 on the basis of the information of the backup window and the information of the degree of distribution of the path of the network used at the time of the backup process. Then, the schedule creation unit 232 sets the corrected provisional backup schedule table T12 as the candidate backup schedule table T13.

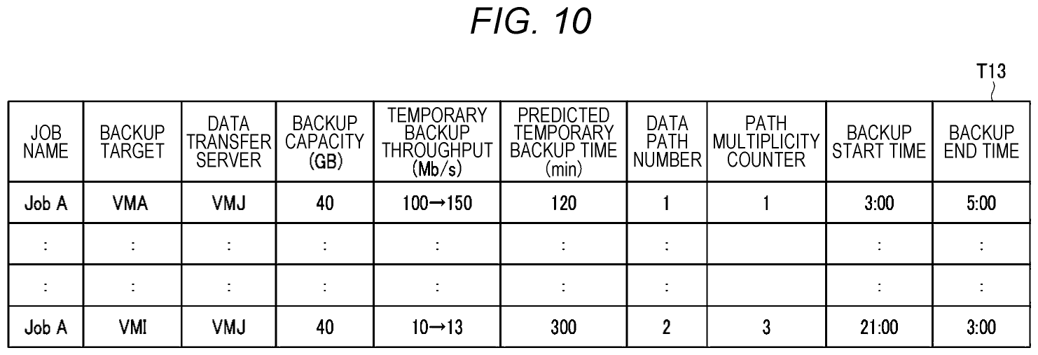

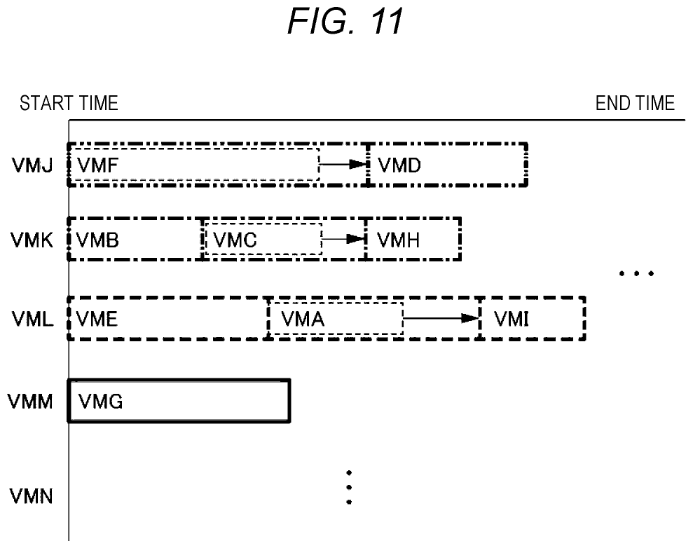

FIG. 10 is a diagram illustrating a configuration example of the candidate backup schedule table T13 which is the modified provisional backup schedule table T12. FIG. 11 is a diagram illustrating an outline of a correction process of the provisional backup schedule table T12 by the schedule creation unit 232. In FIG. 11, the vertical axis represents the data transfer server 13, and the horizontal axis represents a time axis from the backup start time to the end time.

The candidate backup schedule table T13 illustrated in FIG. 10 is different from the provisional backup schedule table T12 before correction in that it has an item “path multiplicity counter”. Since the other items are the same as the items in the provisional backup schedule table T12 illustrated in FIG. 8, the description of the overlapping items is omitted.

A value of a counter indicating the multiplicity of the route of the network is stored in the item “path multiplicity counter”. The multiplicity of the path of the network indicates the degree of use of the network at the time of transmitting the backup data. If the path used in the same time zone in the backup schedule overlaps with the path of other backup data, the value of the path multiplicity counter is counted up. The schedule creation unit 232 corrects the value of the temporary backup throughput of the provisional backup schedule table T12 based on the count value stored in the item “path multiplicity counter”.

In the example illustrated in FIG. 10, the value of the temporary backup throughput at the time of transmitting the backup data from the VMA 12a to the VMJ 13j of the backup job named job A is corrected from “100 (minutes)” to “150 (minutes)”. This correction is performed by the schedule creation unit 232 due to transmission of other backup data in the same time zone in the path of which data path number is “1”.

FIG. 11 illustrates an example in which the predicted backup time of the VMF of the backup target server 12 assigned to the VMJ 13j of the data transfer server 13, the predicted backup time of the VMC 12c assigned to the VMK 13k, and the predicted backup time of the VMA 12a assigned to the VML 13l are corrected to be larger (longer). This correction is performed by the schedule creation unit 232 because the backup data of each of the VMF, the VMC 12c, and the VMA 12a, which are the backup target servers 12, is transmitted using the same data path in the same time zone.

In addition, in a case where the paths through which the backup data is transmitted overlap in the same time zone in which the backup process is performed, the schedule creation unit 232 corrects the temporary backup throughput so that the network throughput in the path fits within the band. Then, the schedule creation unit 232 recalculates the predicted temporary backup time on the basis of the corrected temporary backup throughput. The schedule creation unit 232 also recalculates the backup start and backup end times on the basis of the recalculated values of the temporary backup throughput and the predicted temporary backup time.

In the candidate backup schedule table T13, when there is a combination in which the backup end time does not fit within the backup window time, the schedule creation unit 232 adjusts the value of the candidate backup schedule table T13 again. Specifically, the schedule creation unit 232 changes the combination of the backup target server 12 and the data transfer server 13, changes the order of transmission of the backup data, and the like.

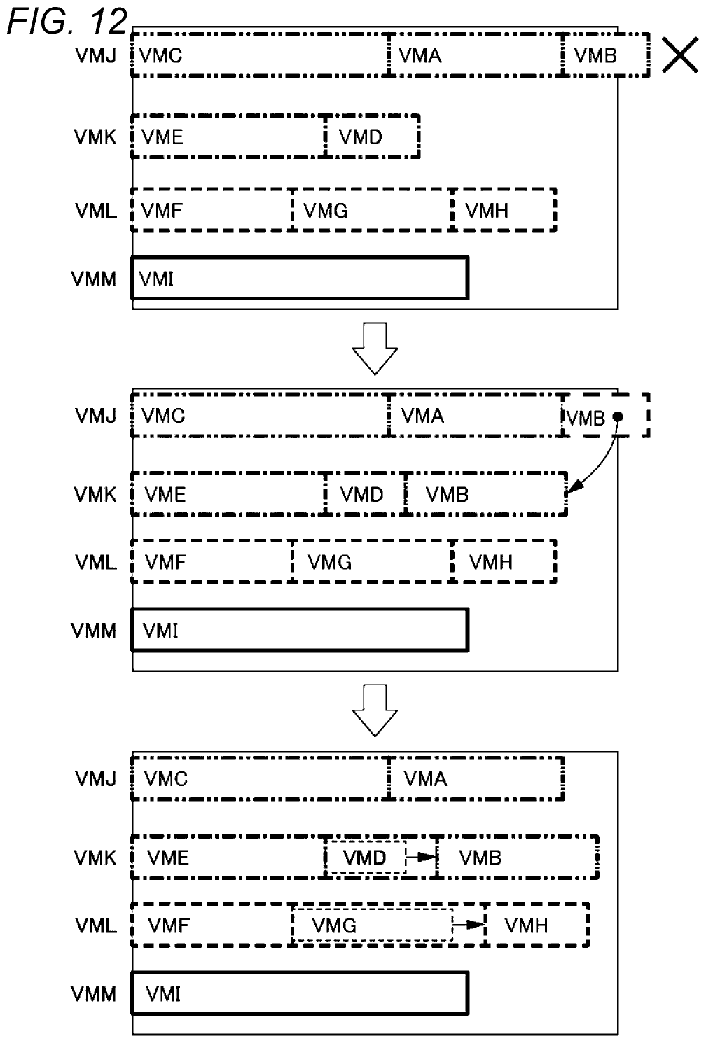

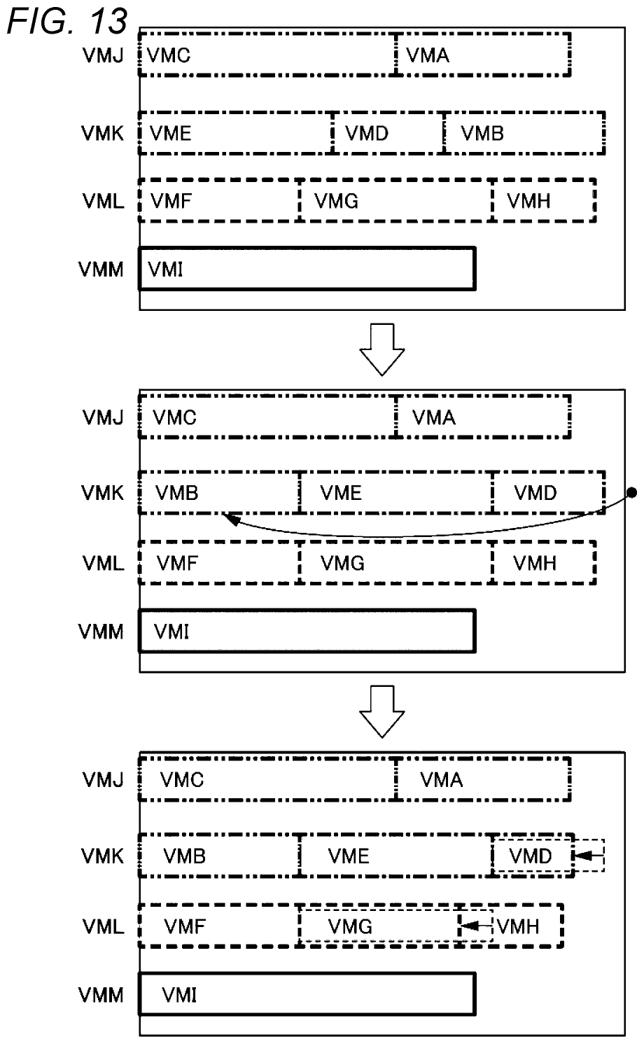

FIGS. 12 and 13 are diagrams illustrating an outline of a correction process of the provisional backup schedule table T12 by the schedule creation unit 232. In FIGS. 12 and 13, the vertical axis represents the data transfer server 13, and the horizontal axis represents a time axis from the backup start time to the end time.

In the example illustrated in the upper part of FIG. 12, in the data transfer server 13 assigned to the VMJ 13j of the data transfer server 13, the time when the backup data of the VMB 12b is transmitted goes out of the backup window indicated by a solid rectangular frame in the figure. Therefore, the schedule creation unit 232 changes the data transfer server 13 that transfers the backup data of the VMB 12b to the VMK 13k having the earliest backup end time.

The middle part of FIG. 12 illustrates a state in which the data transfer server 13 that transfers the backup data of the VMB 12b is changed from the VMJ 13j to the VMK 13k.

In a case where there is a time zone in which the networks to be used overlap in the changed schedule of the data transfer server 13, the schedule creation unit 232 corrects the predicted backup time of the backup data in the time zone.

In the lower part of FIG. 12, the predicted backup time of the backup data of the VMD 12d assigned to the VMK 13k that is the data transfer server 13 and the predicted backup time of the backup data of the VMG assigned to the VML 13l are corrected to be larger (longer).

Furthermore, in a case where it is determined that the multiplicity of the network can be reduced by changing the transfer order of the backup data in the data transfer server 13, the schedule creation unit 232 corrects the transfer order of the backup data.

The upper part of FIG. 13 illustrates the same schedule as the lower part of FIG. 12. The middle part of FIG. 13 illustrates a state in which the time during which the backup data of the VMB 12b assigned to the VMK 13k that is the data transfer server 13 is transferred is replaced with the fastest time zone. Such adjustment performed by the schedule creation unit 232 reduces the multiplicity of the network in the second half (later time) of the backup schedule. As the multiplicity of the network is reduced, the time required to transfer the backup data is shortened, and the predicted backup time is also shortened.

In the lower part of FIG. 13, the predicted backup time of the backup data of the VMD 12d assigned to the VMK 13k that is the data transfer server 13 and the predicted backup time of the backup data of the VMH assigned to the VML 13l are shortened.

The result output unit 24 presents the adjusted provisional backup schedule table T12′ as the candidate backup schedule table T13 to the user via the display unit 230 (see FIG. 2). Then, the schedule management unit 23 creates a final backup schedule on the basis of an instruction from the user who has checked the candidate backup schedule table T13.

### Backup Schedule Management Process

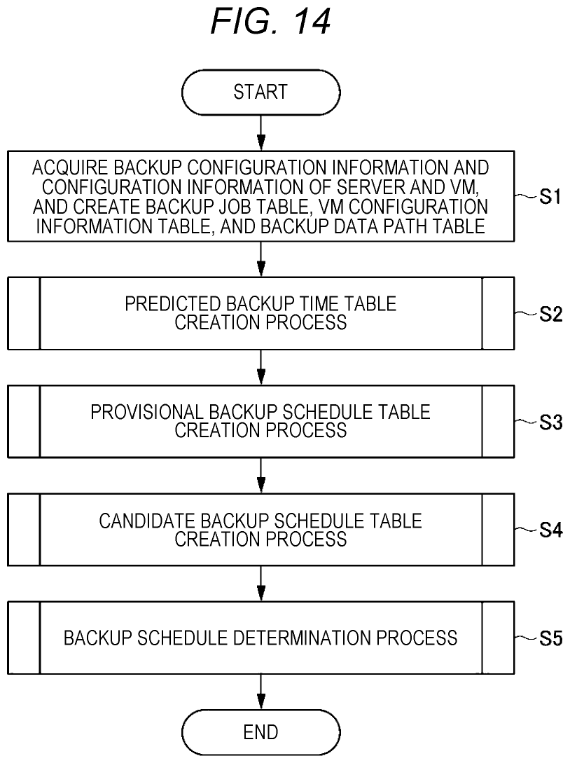

Next, a backup schedule management method by the backup schedule management system 100 according to the present embodiment will be described. FIG. 14 is a flowchart illustrating an example of a procedure of a backup schedule management process by the backup schedule management system 100.

First, the backup configuration information acquisition unit 21 of the backup schedule management device 2 acquires the backup configuration information from the data storage server 14, and the VM configuration information acquisition unit 22 acquires the configuration information of the server 1 and the VM. Then, the backup configuration information acquisition unit 21 creates the backup job table T1, and the VM configuration information acquisition unit 22 creates the VM configuration information table T2 and the backup data path table T3 (step S1).

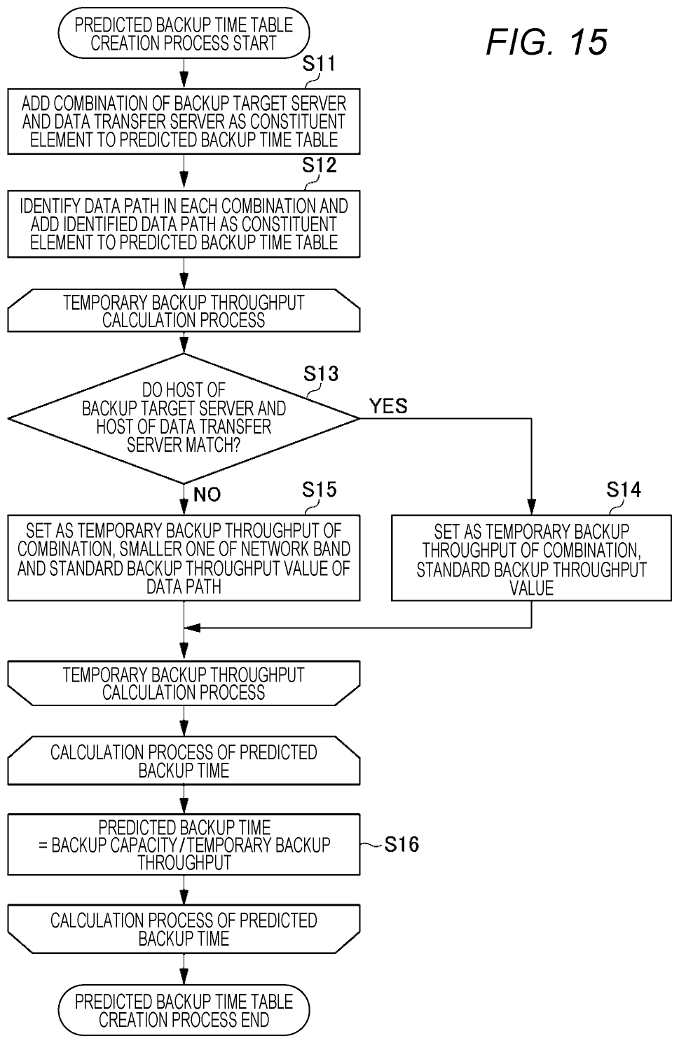

Next, the predicted backup time calculation unit 231 of the schedule management unit 23 performs a predicted backup time table creation process (step S2). The predicted backup time table creation process in step S2 will be described in detail with reference to FIG. 15.

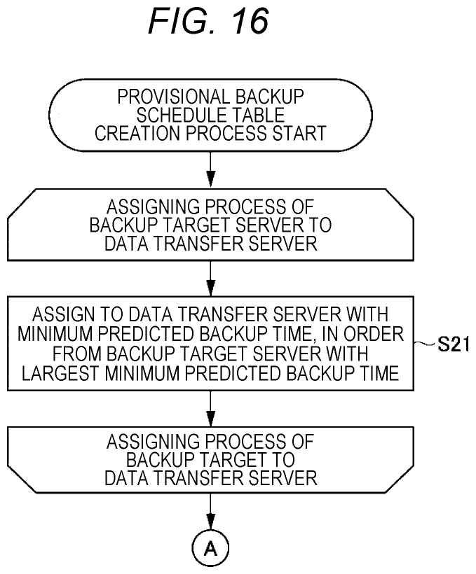

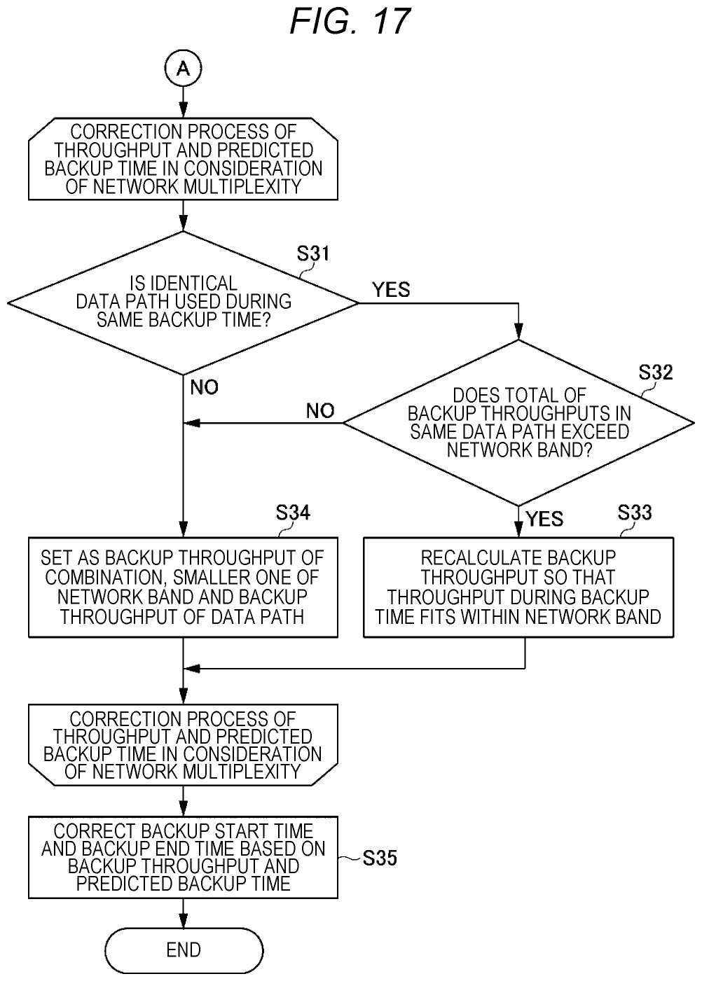

Next, the schedule creation unit 232 of the schedule management unit 23 performs a provisional backup schedule table creation process (step S3). The provisional backup schedule table creation process in step S3 will be described in detail with reference to FIGS. 16 and 17 to be described later.

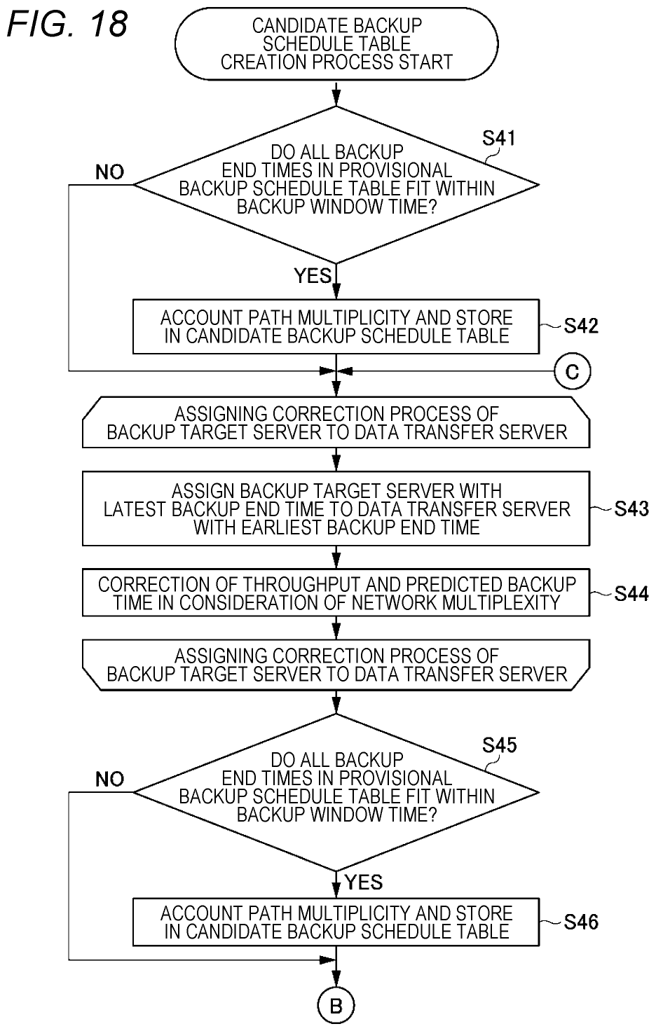

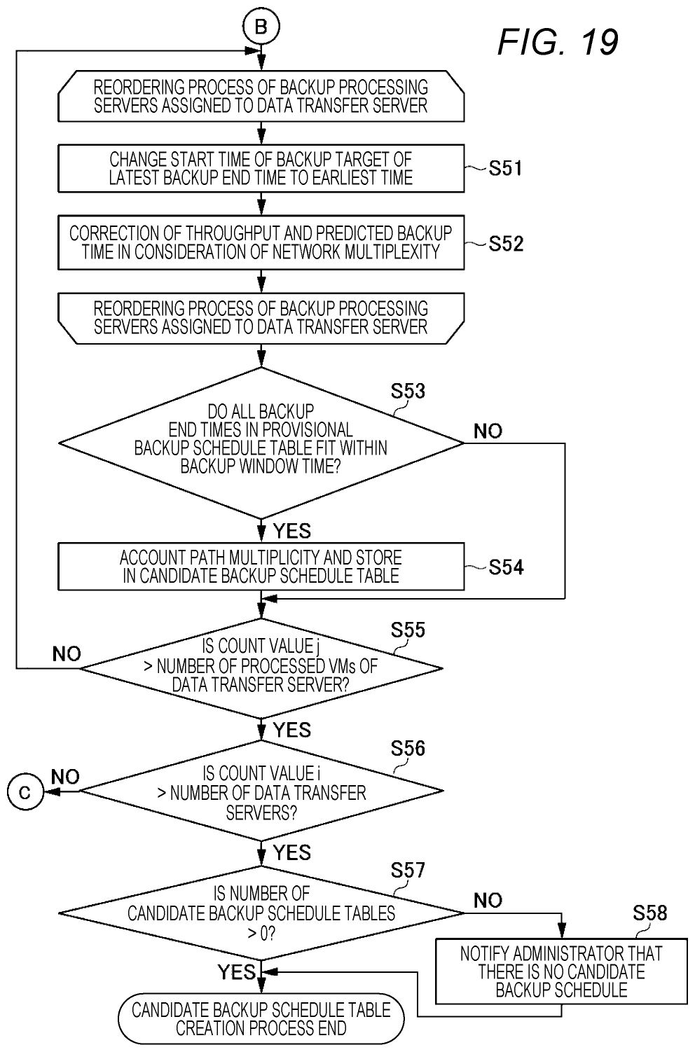

Next, the schedule creation unit 232 performs the candidate backup schedule table creation process (step S4). The candidate backup schedule table creation process in step S4 will be described in detail with reference to FIGS. 18 and 19 to be described later.

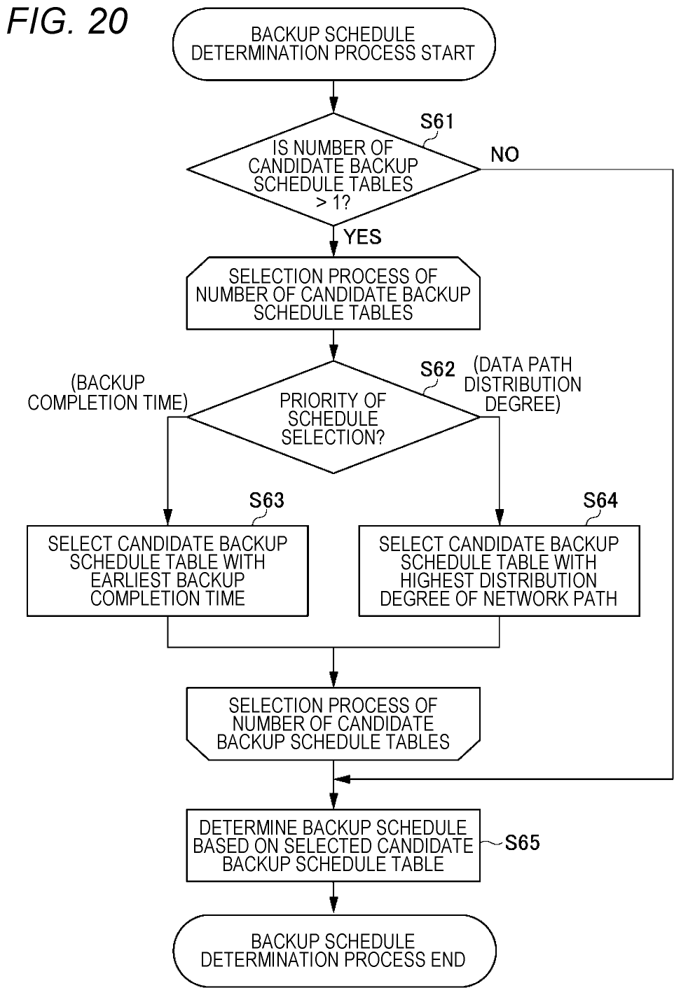

Next, the schedule creation unit 232 performs a backup schedule determination process (step S5). The backup schedule determination process in step S5 will be described in detail with reference to FIG. 20 described later.

### Predicted Backup Time Table Creation Process

Next, the predicted backup time table creation process by the predicted backup time calculation unit 231 will be described with reference to FIG. 15. FIG. 15 is a flowchart illustrating an example of a procedure of the predicted backup time table creation process by the predicted backup time calculation unit 231. First, the predicted backup time calculation unit 231 adds a combination of the backup target server 12 and the data transfer server 13 to the predicted backup time table T11 as a component (step S11).

Next, the predicted backup time calculation unit 231 specifies a data path in each combination of the backup target server 12 and the data transfer server 13, and adds the specified data path to the predicted backup time table T11 as a component (step S12).

Next, the predicted backup time calculation unit 231 performs a temporary backup throughput calculation process. The temporary backup throughput calculation process is performed for (all records corresponding to) all combinations of the backup target server 12 and the data transfer server 13.

In the temporary backup throughput calculation process, the predicted backup time calculation unit 231 first determines whether the host (server) of the backup target server 12 and the host of the data transfer server 13 match (step S13). That is, the predicted backup time calculation unit 231 determines whether or not the transmission of the backup data between the backup target server 12 and the data transfer server 13 is performed in the same server 1.

When it is determined in step S13 that the hosts coincide with each other (YES in step S13), the predicted backup time calculation unit 231 sets the standard backup throughput value to the temporary backup throughput in the combination (step S14). On the other hand, in a case where it is determined in step S13 that the hosts are different from each other (NO in step S13), the predicted backup time calculation unit 231 sets, as the temporary backup throughput of the combination, one having a smaller value out of the network band and the standard backup throughput value of the data path used by the combination of the backup target server 12 and the data transfer server 13 (step S15).

After the process of step S14 or step S15, the predicted backup time calculation unit 231 performs a process of calculating a predicted backup time. The calculation process of the predicted backup time is performed for all records corresponding to all combinations of the backup target server 12 and the data transfer server 13. In the calculation process of the predicted backup time, the predicted backup time calculation unit 231 calculates the predicted backup time by dividing the backup capacity by the temporary backup throughput (step S16). After the process of step S16, the predicted backup time table creation process by the predicted backup time calculation unit 231 ends.

### Provisional Backup Schedule Table Creation Process

Next, a provisional backup schedule table creation process by the schedule creation unit 232 of the schedule management unit 23 will be described with reference to FIGS. 16 and 17. FIGS. 16 and 17 are flowcharts illustrating an example of a procedure of the provisional backup schedule table creation process by the schedule creation unit 232.

In the provisional backup schedule table creation process, the schedule creation unit 232 first performs an assigning process of the backup target server 12 to the data transfer server 13. The assigning process of the backup target servers 12 to the data transfer server 13 is performed by the number of the backup target servers 12. In the assigning process of the backup target server 12, the schedule creation unit 232 assigns the data transfer server 13 having the smallest predicted backup time in order from the backup target server 12 having the largest minimum value of the predicted backup time (step S21). After the process of step S21, the schedule creation unit 232 performs a correction process of the throughput and the predicted backup time in consideration of the network multiplicity (FIG. 17).

The correction process of the throughput and the predicted backup time in consideration of the network multiplicity is performed for all combinations of the backup target server 12 and the data transfer server 13 in each of all the backup jobs. In the correction process of the throughput and the predicted backup time in consideration of the network multiplicity, the schedule creation unit 232 first determines whether or not the same data path is used during the same backup time (step S31).

If it is determined in step S31 that the same data path is used during the same backup time (YES in step S31), the schedule creation unit 232 determines whether the total backup throughput of the backup data transmitted using the same data path exceeds the network band of the data path (step S32). In a case where it is determined in step S32 that the throughput exceeds the network band (YES in step S32), the schedule creation unit 232 recalculates the backup throughput so that the throughput during the backup time fits within the network band (step S33).

If the determination in step S31 is NO or if the determination in step S32 is NO, the schedule creation unit 232 sets, as the backup throughput of the combination, the smaller one of the network band and the standard backup throughput value of the data path used by the combination of the backup target server 12 and the data transfer server 13 (step S34). After the process of step S33 or step S34, the schedule creation unit 232 corrects the predicted backup time using the calculated backup throughput (step S35). After the process of step S35, the provisional backup schedule table creation process by the schedule creation unit 232 ends.

### Candidate Backup Schedule Table Creation Process

Next, the candidate backup schedule table creation process by the schedule creation unit 232 will be described with reference to FIGS. 18 and 19. FIGS. 18 and 19 are flowcharts illustrating an example of a procedure of the candidate backup schedule table creation process by the schedule creation unit 232. As described above, the candidate backup schedule table T13 is a table generated by the schedule creation unit 232 correcting the provisional backup schedule table T12.

First, the schedule creation unit 232 determines whether or not all backup end times of the provisional backup schedule table T12 fit within the backup window time (step S41). If it is determined in step S41 that the end times fit within the backup window time (YES in step S41), the schedule creation unit 232 calculates the path multiplicity of the data path through which the backup data is transmitted, and stores the calculated result in the candidate backup schedule table T13 (step S42).

In a case where the determination in step S41 is NO, or after the process in step S42, the schedule creation unit 232 performs correction process of the assignment of the backup target server to the data transfer server. In the correction process of the assignment of the backup target server to the data transfer server, the schedule creation unit 232 performs process of assigning the backup target server 12 having the latest backup end time to the data transfer server 13 having the earliest backup end time (step S43). The process in step S43 is the process described with reference to FIG. 12.

Next, the schedule creation unit 232 corrects the throughput and the predicted backup time in consideration of the network multiplicity (step S44). The process in step S44 is the process described with reference to FIG. 13.

After the process of step S44, the schedule creation unit 232 again determines whether or not all backup end times in the provisional backup schedule table T12 fit within the backup window time (step S45). If it is determined in step S45 that the end times fit within the backup window time (YES in step S45), the schedule creation unit 232 calculates the path multiplicity of the data path through which the backup data is transmitted, and stores the calculated result in the candidate backup schedule table T13 (step S46).

On the other hand, in a case where it is determined in step S45 that there is a backup end time that does not fit within the backup window time (NO in step S45), or after the process in step S46, the schedule creation unit 232 performs process of rearranging the process order of the backup target server assigned to the data transfer server (FIG. 19).

In the order rearranging process of the backup process server assigned to the data transfer server, the schedule creation unit 232 first changes the backup start time by the backup target server having the latest backup end time to the earliest time in the backup process (step S51). Next, the schedule creation unit 232 corrects the throughput and the predicted backup time in consideration of the network multiplicity (step S52).

After the process of step S52, the schedule creation unit 232 again determines whether all backup end times in the provisional backup schedule table T12 fit within the backup window time (step S53). If it is determined in step S53 that the end times fit within the backup window time (YES in step S53), the schedule creation unit 232 calculates the path multiplicity of the data path through which the backup data is transmitted, and stores the calculated result in the candidate backup schedule table T13 (step S54).

After the process of step S54 or when it is determined in step S53 that there is a backup end time that does not fit within the backup window time (NO in step S53), the schedule creation unit 232 performs the determination of step S55. In step S55, the schedule creation unit 232 determines whether or not the count value j indicating the number of backup process (the number of backup target servers 12) in the data transfer server 13 targeted in the process so far exceeds the number of data transfer servers 13. In a case where it is determined in step S55 that “the count value j≤the number of backup processes in the data transfer server 13” (NO in step S55), the schedule creation unit 232 performs a process of rearranging the order of the backup process servers assigned to the data transfer server (steps S51 and S52).

On the other hand, when it is determined in step S55 that “the count value j>the number of backup process in the data transfer server 13” (YES in step S55), the schedule creation unit 232 determines whether or not the count value i indicating the number of data transfer servers targeted in the process so far exceeds the actual number of data transfer servers 13 (step S56). In a case where it is determined in step S56 that “the count value i≤the number of data transfer servers 13” (NO in step S56), the schedule creation unit 232 performs a correction process (steps S43 and S44 in FIG. 18) of the assignment of the backup target server to the data transfer server in FIG. 18.

On the other hand, when it is determined in step S56 that “the count value i>the number of data transfer servers 13” (YES in step S56), the schedule creation unit 232 determines whether the number of candidate backup schedule tables T13 created in the process so far is larger than 0 (step S57). When it is determined in step S57 that the number of created candidate backup schedule tables T13 is at least 1 (YES in step S57), the candidate backup schedule table creation process by the schedule creation unit 232 ends.

On the other hand, when it is determined that the number of created candidate backup schedule tables T13 is 0 (NO in step S57), the result output unit 24 notifies the administrator that there is no candidate backup schedule (step S58). For example, in a case where the backup data capacity increases more rapidly than expected, there may be a case where only a schedule in which the end time of the backup process does not fit within the backup window time can be created, that is, a case where a candidate backup schedule cannot be created. Even in such a case, according to the present embodiment, since the administrator is notified of the notification, the administrator can take measures before executing the backup process. After the process of step S58, the candidate backup schedule table creation process by the schedule creation unit 232 ends.

### Backup Schedule Determination Process

Next, a backup schedule determination process by the schedule creation unit 232 will be described with reference to FIG. 20. FIG. 20 is a flowchart illustrating an example of a procedure of the backup schedule determination process by the schedule creation unit 232. The process illustrated in FIG. 20 is based on the assumption that the schedule creation unit 232 creates a plurality of types of candidate backup schedule tables T13 according to the obtained effect. The plurality of types of candidate backup schedule tables T13 include, for example, a candidate backup schedule table T13 that can make the backup completion time earlier, a candidate backup schedule table T13 that can increase the degree of dispersion of the data path, and the like.

First, the schedule creation unit 232 determines whether the number of created candidate backup schedule tables T13 is larger than “1” (step S61). When it is determined in step S61 that the number of candidate backup schedule tables T13 is larger than “1” (YES in step S61), the schedule creation unit 232 performs a selection process of a candidate backup schedule table.

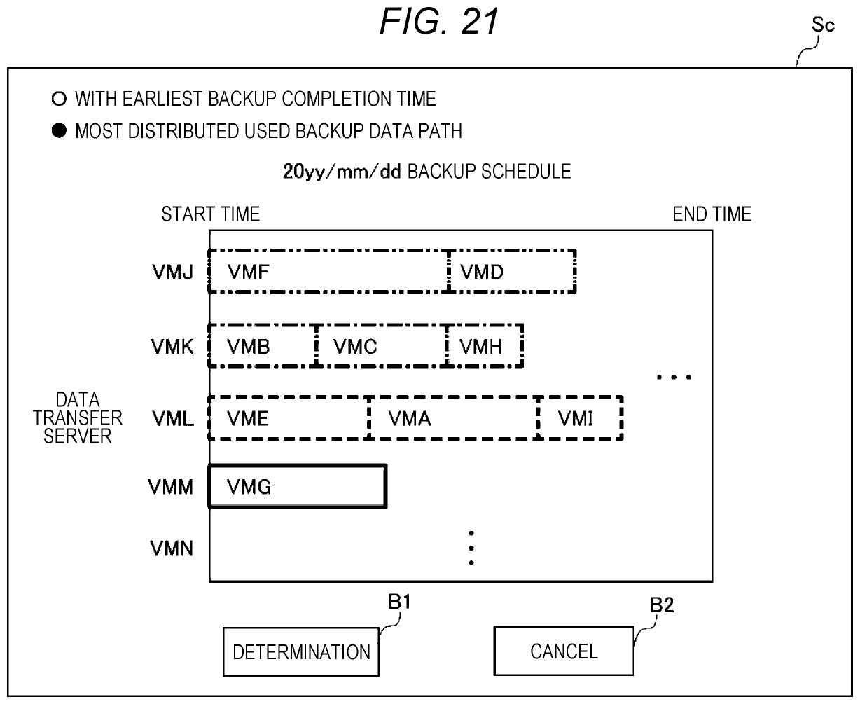

In the selection process of the candidate backup schedule table, the schedule creation unit 232 determines whether the priority of the schedule selection is the backup completion time or the degree of dispersion of the data path (step S62). The schedule creation unit 232 can determine the priority of schedule selection on the basis of, for example, an instruction or the like by the user on a candidate backup schedule selection screen Sc illustrated in FIG. 21 below. The configuration of the candidate backup schedule selection screen Sc will be described later with reference to FIG. 21.

When the schedule selection priority is the backup completion time, the schedule creation unit 232 selects the candidate backup schedule table T13 having the earliest backup completion time (step S63). On the other hand, when the schedule selection priority is the degree of dispersion of the data paths, the schedule creation unit 232 selects the candidate backup schedule table T13 having the largest degree of dispersion of the data paths (step S64).

If NO is determined in step S61, or after the process in step S63 or step S64, the schedule creation unit 232 determines a backup schedule on the basis of the selected candidate backup schedule table T13 (step S65). If the determination in step S61 is NO, that is, if the number of candidate backup schedule tables T13 is 1 or less, the schedule creation unit 232 determines a backup schedule on the basis of the candidate backup schedule table T13. After the process of step S65, the backup schedule determination process by the schedule creation unit 232 ends.

FIG. 21 is a diagram illustrating a configuration example of a candidate backup schedule selection screen Sc. As illustrated in FIG. 21, an option “with earliest backup completion time” and an option “most distributed used backup data path” are displayed in the upper left part of the candidate backup schedule selection screen Sc. The example illustrated in FIG. 21 illustrates a state in which the second option “most distributed used backup data path” is selected.

Below this option is a table labeled “20yy/mm/dd Backup Schedule”. The table is a graph shown in the lower part of FIG. 13 and the like. That is, it is a table in which the backup target server 12 corresponding to each backup process in the data transfer server 13 is assigned in the time order of the backup schedule. By selecting one of the options at the top of the table, the user can display the schedule according to the schedule selection priority indicated in the option on the candidate backup schedule selection screen Sc.

A determination button B1 and a cancel button B2 are disposed below the table. When the user presses the determination button B1, the backup schedule displayed on the candidate backup schedule selection screen Sc is applied to each data transfer server 13.

### Predicted Backup Time Table Update Process

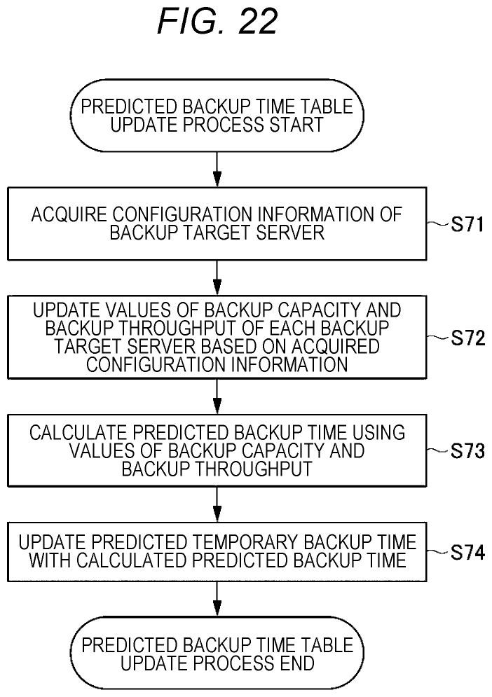

Next, the predicted backup time table update process by the schedule creation unit 232 will be described with reference to FIG. 22. FIG. 22 is a flowchart illustrating an example of a procedure of a predicted backup time table update process by the schedule creation unit 232.

First, the schedule creation unit 232 acquires configuration information of the backup target server after the backup process (step S71). Next, the schedule creation unit 232 updates the values of the backup capacity and the backup throughput of each backup target server 12 in the predicted backup time table T11 on the basis of the acquired configuration information (step S72).

Next, the schedule creation unit 232 calculates a predicted backup time using the updated values of the backup capacity and the backup throughput (step S73). Next, the schedule creation unit 232 updates the predicted temporary backup time of the predicted backup time table T11 with the calculated predicted backup time (step S74). After the process of step S74, the predicted backup time table update process by the schedule creation unit 232 ends.

### Various Effects

In the above-described embodiment, the predicted backup time calculation unit 231 calculates a predicted backup time for each combination of the data transfer server 13 and the backup target server 12 on the basis of a temporary backup throughput at the time of transmission of the backup data and a used capacity of the backup data in the backup target server 12. In addition, the schedule creation unit 232 sequentially assigns a backup process of the backup target server 12 to the data transfer server 13 on the basis of the information of the predicted backup time and the information of the degree of use of the network during execution of the backup process, and creates the backup schedule on the basis of a result of the assignment.

The time required for the backup process varies depending on the combination of the data transfer server 13 and the backup target server 12, the data capacity of the backup target server 12, the degree of use of the network, and the like. In the present embodiment, since the backup schedule is created in consideration of these factors, according to the present embodiment, it is possible to create an appropriate backup schedule even in a system in which it is difficult to predict a change in the capacity of the backup data. Further, according to the present embodiment, since the backup schedule management device 2 automatically creates the backup schedule, it is possible to save time and effort for the administrator or the like to create or adjust the backup schedule.

In addition, in the above-described embodiment, the schedule creation unit 232 assigns the backup process of the backup target server 12 to the data transfer server 13 capable of minimizing the predicted backup time. Therefore, according to the present embodiment, a backup schedule capable of further hastening the completion time of the backup is created.

Furthermore, in the above-described embodiment, the schedule creation unit 232 corrects the predicted backup time in each combination of the data transfer server 13 and the backup target server 12 to a longer time in a time zone in which the degree of use of the network is assumed to be high by executing the backup process. Therefore, according to the present embodiment, it is possible to create a backup schedule according to the usage status of the network.

In addition, in the above-described embodiment, in a case where there is the data transfer server 13 in which the end time of the backup process does not fit within the backup window time, the schedule creation unit 232 transfers the backup process performed outside the time of the backup window to the data transfer server 13 in which the end time of the backup process is the earliest. Therefore, according to the present embodiment, it is possible to create a backup schedule in consideration of the backup window.

In addition, in the above-described embodiment, the schedule creation unit 232 changes the order of the backup process of the backup target server 12 assigned to the data transfer server 13 so as to enable reduction in the degree of use of the network. Therefore, according to the present embodiment, a backup schedule capable of further hastening the completion time of the backup is created.

In addition, in the above-described embodiment, the result output unit 24 presents both the candidate backup schedule prioritized in the backup completion time and the candidate backup schedule prioritized in the distribution degree of the data path to the user. Then, the schedule creation unit 232 creates a backup schedule on the basis of the candidate backup schedule selected by the user. Therefore, according to the present embodiment, a backup schedule based on the matters prioritized by the user is created.

Furthermore, in the above-described embodiment, the schedule creation unit 232 acquires information of the used capacity of the backup data in each of the plurality of backup target servers 12 after the end of the backup process based on the created backup schedule. Then, the schedule creation unit 232 calculates the predicted backup time based on the acquired information of the used capacity of the backup data, and updates the predicted backup time before the execution of the backup process with the predicted backup time after the calculation. Therefore, according to the present embodiment, since the information of the actual value of the backup process is fed back to the creation of the subsequent backup schedule, it is possible to constantly improve the accuracy of the creation of the backup schedule by the schedule creation unit 232.

Note that, in the above-described embodiment, an example has been described in which the backup schedule management system according to the present invention is applied to a virtualization system implemented using a hypervisor technology, but the present invention is not limited thereto. The backup schedule management system according to the present invention may be applied to a virtualization system realized using another virtualization technology such as a container. In addition, as long as the combination of the backup target server 12 and the data transfer server 13 can be dynamically changed, the present invention may be applied to a system realized without using the virtualization technology.

In addition, in the above-described embodiment, an example has been described in which the predicted backup time calculation unit 231 and the schedule creation unit 232 calculate the predicted backup time and create the backup schedule using each value stored in various tables, but the present invention is not limited thereto. For example, in the backup schedule management system according to the present invention, the functions of the predicted backup time calculation unit 231 and the schedule creation unit 232 may be configured as a machine learning model, and the backup schedule may be output from the machine learning model as an inference result.

In addition, the above-described embodiments have described the configurations of the system specifically and in detail for the sake of easy understanding of the present invention, and are not necessarily limited to those provided with all the described configurations. In addition, control lines or information lines indicated by solid arrows shown in FIGS. 1 and 2 are only those considered necessary for description, and not necessarily all the control lines and the information lines in the product are shown. In practice, it may be considered that almost all the configurations are connected to each other.

Furthermore, in the present specification, the processing steps describing the time-series processing include not only processing carried out in time series according to the described order, but also processing executed in parallel or individually (for example, parallel processing or processing by an object) even if the processing is not necessarily carried out in time series.

What is claimed is:

1. A backup schedule creation device that creates a backup schedule for a backup process in a backup schedule management system in which a plurality of backup target servers having backup data to be backed up in a data storage server and a plurality of data transfer servers that acquire the backup data from the backup target servers and transfer the backup data to the data storage server are connected to each other via a network, the backup schedule creation device comprising:
a predicted backup time calculation unit that calculates a predicted backup time for each combination of the data transfer server and the backup target server on the basis of an estimated backup throughput at the time of transmission of the backup data and a used capacity of the backup data in the backup target server; and
a schedule creation unit that sequentially assigns a backup process of the backup data of the backup target server to the data transfer server on the basis of the information of the predicted backup time and the information of the degree of use of the network during execution of the backup process, and creates the backup schedule on the basis of a result of the assignment.

2. The backup schedule creation device according to claim 1, wherein the schedule creation unit assigns a backup process of the backup target server to the data transfer server capable of minimizing the predicted backup time.

3. The backup schedule creation device according to claim 2, wherein the predicted backup time calculation unit calculates the estimated backup throughput on the basis of information on a network band in a path of the network connecting the data transfer server and the backup target server.

4. The backup schedule creation device according to claim 3, wherein the schedule creation unit corrects the predicted backup time in each combination of the data transfer server and the backup target server to be longer in a time zone in which the degree of use of the network is assumed to be high by executing the backup process in the combination of the plurality of data transfer servers and the backup target server.

5. The backup schedule creation device according to claim 4, wherein
in a case where there is the data transfer server in which the end time of the backup process does not fit within the backup window time, the schedule creation unit transfers the backup process performed outside the time of the backup window to the data transfer server in which the end time of the backup process is the earliest.

6. The backup schedule creation device according to claim 5, wherein the schedule creation unit changes the order of the backup process of the backup target server assigned to the data transfer server so as to enable reduction in the degree of use of the network.

7. The backup schedule creation device according to claim 6, wherein the schedule creation unit creates a candidate for a backup schedule capable of further hastening an end time of the backup process and a candidate for a backup schedule capable of further reducing a degree of use of the network, selects one of the candidates on the basis of a preset priority or an instruction input via an operation input unit, and creates the backup schedule on the basis of the selected candidate.

8. The backup schedule creation device according to claim 7, wherein the schedule creation unit acquires information of the used capacity of the backup data in each of the plurality of backup target servers after the end of the backup process based on the created backup schedule, calculates the predicted backup time on the basis of the acquired information of the used capacity of the backup data, and updates the predicted backup time before the execution of the backup process with the calculated predicted backup time.

9. A backup schedule creation method by a backup schedule creation device that creates a backup schedule for a backup process in a backup schedule management system in which a plurality of backup target servers having backup data to be backed up in a data storage server and a plurality of data transfer servers that acquire the backup data from the backup target servers and transfer the backup data to the data storage server are connected to each other via a network, the backup schedule creation method comprising:
by a predicted backup time calculation unit, calculating a predicted backup time for each combination of the data transfer server and the backup target server on the basis of an estimated backup throughput at the time of transmission of the backup data and a used capacity of the backup data in the backup target server; and
by a schedule creation unit, sequentially assigning a backup process of the backup data of the backup target server to the data transfer server on the basis of the information of the predicted backup time and the information of the degree of use of the network during execution of the backup process, and creating the backup schedule on the basis of a result of the assignment.
